(19) United States
(12) Patent Application Publication
(10) Pub. No.: US 2007/0230628 A1
(43) Pub. Date: Oct. 4, 2007

(54) Apparatus and method for detecting a signal in a communication system using Multiple Input Multiple Output scheme

(75) Inventors: Cheol-Woo You, Seoul (KR); Dong-Ho Kim, Seoul (KR); Yung-Soo Kim, Seongnam-si (KR); Seung-Hoon Nam, Seoul (KR); Hyun-Cheol Park, Daejeon (KR); Nam-Shik Kim, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignees: SUMSUNG ELECTRONICS CO., LTD., Suwon-si (KR); Korea Advnaced Institute of Science and Technology (KAIST), Daejon (KR)

(21) Appl. No.: 11/716,343

(22) Filed: Mar. 9, 2007

(30) Foreign Application Priority Data
Mar. 9, 2006 (KR) 2006-0022246

(51) Int. Cl. H04L 27/06; H04L 1/02

(52) U.S. Cl. 375/340; 375/347

(57) ABSTRACT

An apparatus is provided for detecting a signal in a communication system using a Multiple Input Multiple Output (MIMO) scheme. The signal detection apparatus includes a detector for generating second matrixes by extending a first matrix composed of channel response vectors, generating specific matrixes by decomposing the second matrixes, generating a lattice point of vectors constituting the second matrixes, estimating a signal using the generated specific matrixes and lattice point, and detecting the estimated signal as a received signal if the estimated signal has a value within a predetermined allowable range.

### PRIORITY

This application claims priority under 35 U.S.C. § 119(a) to an application filed in the Korean Intellectual Property Office on Mar. 9, 2006 and assigned Serial No. 2006-22246, the contents of which are incorporated herein by reference.

### BACKGROUND OF THE INVENTION

1. Field of the Invention

The present invention relates generally to an apparatus and method for detecting a signal in a communication system, and in particular, to an apparatus and method for detecting a signal in a Multiple Input Multiple Output (MIMO) communication system.

2. Description of the Related Art

The key issue in communication is to transmit data over a channel efficiently and reliably. In the next generation multimedia mobile communication system now under study, to meet the demand for a high-speed communication system capable of processing and transmitting a variety of information such as image and radio data, surpassing the early voice-oriented service, it is necessary to increase system efficiency with the use of a channel coding scheme suitable for the system.

However, a wireless channel environment in the mobile communication system, unlike the wired channel environment, suffers from information loss, as unavoidable errors occur due to several factors such as multi-path interference, shadowing, propagation attenuation, time-varying noise, interference, fading, etc.

The information loss actually results in considerable distortion for transmission signals, causing a decrease in the overall performance of the mobile communication system. Generally, in order to reduce the information loss, various error control techniques are used for increasing system reliability according to characteristics of the channel, and a typical error control technique uses error correction codes.

Further, in order to avoid unstable communication due to fading, a diversity scheme is used, which is roughly classified into a time diversity scheme, a frequency diversity scheme, and an antenna diversity scheme, or space diversity scheme.

The antenna diversity scheme, a scheme using multiple antennas, is further classified into a reception antenna diversity scheme including a plurality of reception antennas, a transmission antenna diversity scheme including a plurality of transmission antennas, and a Multiple Input Multiple Output (MIMO) scheme including a plurality of reception antennas and a plurality of transmission antennas. With reference to FIG. 1, a description will now be made of a structure of a transmitter in a communication system using the MIMO scheme (hereinafter “MIMO communication system”).

FIG. 1 schematically illustrates a structure of a transmitter in a MIMO communication system.

Referring to FIG. 1, the transmitter includes a modulator 111, an encoder 113, and a plurality of transmission antennas Tx.ANT, namely, a first transmission antenna Tx.ANT #1 115-1 to an Nₜ^{th} transmission antenna Tx.ANT #Nₜ 115-Nₜ.

The modulator 111 modulates input information data bits into modulation symbols using a predetermined modulation scheme, and outputs the modulation symbols to the encoder 113. The modulation scheme used herein may include at least one of Binary Phase Shift Keying (BPSK), Quadrature Phase Shift Keying (QPSK), Quadrature Amplitude Modulation (QAM), Pulse Amplitude Modulation (PAM), and Phase Shift Keying (PSK).

The encoder 113 encodes the serial modulation symbols output from the modulator 111 using a predetermined coding scheme, and transmits the coded symbols via the first transmission antenna 115-1 to the Nₜ transmission antenna 115-Nₜ. Generally, the coding scheme of the encoder 113 includes a scheme of parallel-converting the serial modulation symbols output from the modulator 111 according to the number of the transmission antennas. Herein, a transmission vector composed of the signals transmitted via the Nₜ transmission antennas is defined as Equation (1):
x_{c}=[x₁,x₂, . . . ,x_{N}_{ₖ}]^{T} (1)

FIG. 2 is a diagram schematically illustrating a structure of a receiver in a MIMO communication system.

Referring to FIG. 2, the receiver includes a plurality of, for example, Nᵣ reception antennas Rx.ANT, namely, a first reception antenna Rx.ANT #1 211-1 to an Nᵣ^{th} reception antenna Rx.ANT #Nᵣ 211 Nᵣ, a detector 213, and a demodulator 215.

The signals transmitted from the transmitter via the Nₜ transmission antennas as shown in FIG. 1 are received via the first reception antenna 211-1 to the Nᵣ^{th} reception antenna 211-Nᵣ. Herein, a received vector composed of the signals received via the first reception antenna 211-1 to the Nᵣ^{th} reception antenna 211-Nᵣ is defined as:
y_{c}=[y₁,y₂, . . . ,y_{N}_{ᵣ}]^{T} (2)
The received vector y_{c} can be expressed as:
y_{c}=H_{c}x_{c}+n_{c} (3)

In Equation (3), H_{c} denotes a channel response vector composed of channel responses of the first reception antenna 211-1 to the Nᵣ^{th} reception antenna 211-Nᵣ, and n_{c} denotes a noise vector composed of noise signals received via the first reception antenna 211-1 to the Nᵣ^{th} reception antenna 211-Nᵣ. It will be assumed herein that the channel response vector H_{c} can be expressed as an Nₜ×Nᵣ matrix and a channel between the transmitter and the receiver is a flat fading channel.

Although the foregoing transmission/reception signal vectors x_{c}, y_{c} and n_{c}, and the channel response vector H_{c} all have a complex value, they can be expressed in a real number as shown in Equation (4), for the sake of convenience.

$$\begin{matrix}y = Hx + n \\ In Equation ( 4 ) , x = [ \begin{matrix}Re \{ {x}_{c} \} \\ Im \{ {x}_{c} \}\end{matrix} ] , y = [ \begin{matrix}Re \{ {y}_{c} \} \\ Im \{ {y}_{c} \}\end{matrix} ] , n = [ \begin{matrix}Re \{ {n}_{c} \} \\ Im \{ {n}_{c} \}\end{matrix} ] , \\ and H = [ \begin{matrix}Re \{ {H}_{c} \} & - Im \{ {H}_{c} ] \\ Im \{ {H}_{c} \} & Re \{ {H}_{c} \}\end{matrix} ] .\end{matrix} \qquad ( 4 )$$

The received vector y_{c} composed of the signals received via the first reception antenna 211-1 to the Nᵣ^{th} reception antenna 211-Nᵣ is delivered to the detector 213. The detector 213 detects the signals received via the first reception antenna 211-1 to the Nᵣ^{th} reception antenna 211-Nᵣ, and outputs the detected signals to the demodulator 215. The demodulator 215 demodulates the signals output from the detector 213 into the original information data bits using a demodulation scheme corresponding to the modulation scheme used in the modulator 111 of the transmitter.

The typical schemes of detecting the symbols which are simultaneously transmitted/received in the MIMO communication system may include a Zero Forcing (ZF) scheme, a Minimum Mean Square Error (MMSE) scheme, a Successive Interference Cancellation (SIC) scheme, a Sphere Decoding (SD) scheme, and a Maximum Likelihood (ML) scheme.

The use of the ZF, MMSE and SIC schemes among the above signal detection schemes enables low-complexity implementation of signal detection, but may decrease signal detection performance in a poor channel state. On the contrary, the use of the SD and ML schemes contributes to an increase in the signal detection performance, but may increase the required calculations, i.e. the complexity.

### SUMMARY OF THE INVENTION

An object of the present invention is to substantially provide an apparatus and method for detecting a signal with low complexity in a MIMO communication system.

Another object of the present invention is to provide a signal detection apparatus and method for guaranteeing signal detection performance with minimum complexity in a MIMO communication system.

According to one aspect of the present invention, there is provided a method for detecting a signal in a communication system using a Multiple Input Multiple Output (MIMO) scheme. The signal detection method includes generating second matrixes by extending a first matrix composed of channel response vectors; generating specific matrixes by decomposing the second matrixes, and generating a lattice point of vectors constituting the second matrixes; estimating a signal using the generated specific matrixes and lattice point; and detecting the estimated signal as a received signal if the estimated signal has a value within a predetermined allowable range.

According to one aspect of the present invention, there is provided an apparatus for detecting a signal in a communication system using a Multiple Input Multiple Output (MIMO) scheme. The signal detection apparatus includes a detector for generating second matrixes by extending a first matrix composed of channel response vectors, generating specific matrixes by decomposing the second matrixes, generating a lattice point of vectors constituting the second matrixes, estimating a signal using the generated specific matrixes and lattice point, and detecting the estimated signal as a received signal if the estimated signal has a value within a predetermined allowable range.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a structure of a transmitter in a MIMO communication system;

FIG. 2 is a diagram schematically illustrating a structure of a receiver in a MIMO communication system;

FIG. 3 is a diagram illustrating vectors obtained through a channel response matrix according to the present invention; and

FIG. 4 is a flowchart schematically illustrating an operation of a receiver in a MIMO communication system according to the present invention.

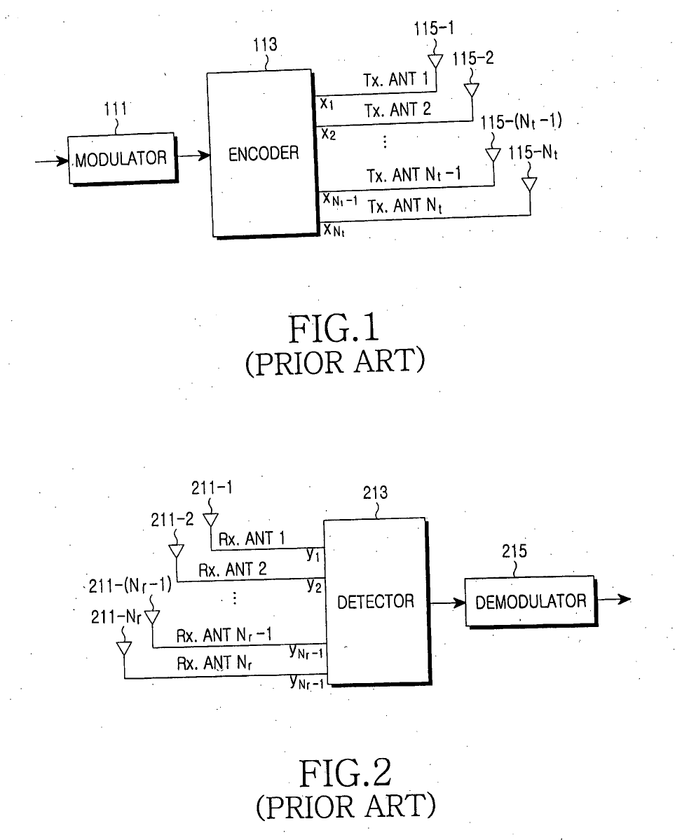

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a signal detection apparatus and method for minimizing calculations in a mobile communication system using a space diversity scheme, for example, Multiple Input Multiple Output (MIMO) scheme (hereinafter “MIMO communication system”).

Before a description of the present invention is given, it should be noted that the present invention uses a Lattice Reduction (LR) technique. The LR technique detects a signal using a lattice point generated by a channel response matrix H for the channel between a transmitter and a receiver of a given communication system, and the lattice point is expressed as Equation (5):

$$L ( H ) = \{ {\sum }_{i} {k}_{i} {h}_{i} \vert {k}_{i} ∈ Z and H = [ {h}_{1} , ⋯ , {h}_{m} ] \} \qquad ( 5 )$$

where k denotes an integer, and i denotes each of indexes of m vectors constituting elements of a channel response matrix, and has a value between 1 and m.

A description will now be made of an LR-based signal detection scheme of a receiver.

First, the receiver can detect a signal using a Zero Forcing (ZF) scheme. In this case, the receiver cancels interference by multiplying a channel response matrix H by a Moore-Penrose Pseudo-inverse matrix. If the channel response matrix H is orthogonal, the ZF signal detection scheme performs the same signal detection operation as that of the ML signal detection scheme. The ZF signal detection scheme may suffer performance degradation due to noise amplification.

Therefore, the performance is improved by converting the channel response matrix H into a roughly orthogonal form using the LR technique. A Lattice Reduction-Zero Forcing (LR-ZF) scheme used in the receiver will now be described using Equation (6).
y=Hx+n=HTT⁻¹x+n=\tilde{H}z+n
z_{ZF}=(\tilde{H})⁺yx_{LR-ZF}=T·Q(z_{ZF}) (6)

In Equation (6), y denotes a channel response, and x denotes a received signal transmitted from a transmitter. Further, ( )⁺ denotes a notation indicating an operation with the Moore-Penrose Pseudo-inverse matrix, Q denotes a quantization function, and z denotes a value calculated in an interim step to estimate an actual signal transmitted by the transmitter.

Second, the receiver can also detect a signal using a Minimum Mean Square Error (MMSE) scheme, and considers noises so that a mean square error is minimized during the signal detection. Therefore, the use of the MMSE scheme, compared with the use of the ZF scheme, decreases noise amplification, contributing to the performance improvement. A Lattice Reduction-Minimum Mean Square Error (LR-MMSE) scheme used in the receiver will now be described using Equation (7).
y=Hx+n=HTT⁻¹x+n=\tilde{H}z+n
z_{MMSE}=(\tilde{H}^{T}\tilde{H}+σ²T^{T}T)⁻¹\tilde{H}^{T}yx_{LR-MMSE}=T·Q(z_{MMSE}) (7)
where σ denotes noise strength, R denotes an upper triangular matrix, T denotes a unimodular matrix, and Q( ) denotes a quantization matrix.

Third, the receiver can detect a signal using a Lenstra-Lenstra-Lovasz (LLL) algorithm. For performance improvement of the LR-MMSE scheme, a channel response matrix is generated by extending a channel. The receiver generates an extended channel response matrix H by extending the channel using an extended signal matrix x for the extended channel response.

The extended channel response matrix is expressed as

$$\underline{H} = [ \begin{matrix}H \\ {σ}^{2} I\end{matrix} ] ,$$

and the extended signal matrix is expressed as

$$\underline{x} = [ \begin{matrix}x \\ {0}_{m , 1}\end{matrix} ] .$$

In the extended channel response matrix H, σ denotes noise strength and I denotes an identity matrix.

Therefore, \tilde{H} and T satisfying a relation Ĥ=HT can be calculated using the LLL algorithm. Signal detection using the above relation is expressed as Equation (8).
z_{MMSE}^{H}=(\tilde{H})⁺yx_{LR}_{_{—}}_{MMSE}^{H}=T·Q(z_{MMSE}^{H}) (8)

The LR technique converts bases, i.e. column vectors of the channel response matrix H for a channel between a transmitter and a receiver of a given communication system into a roughly orthogonal form. As a result, a converted channel response matrix \tilde{H} composed of the converted vectors can be found. Because a condition number of the matrix \tilde{H} is higher than that of the matrix H, the signal detection based on the matrix \tilde{H} can improve the performance as compared with the signal detection based on the matrix H. The condition number indicates det(H)·det(H⁻¹) for the matrix H.

If a lattice point corresponding to the matrix H is identical to a lattice point corresponding to the matrix \tilde{H}, the following condition is satisfied in Equation (9):
L(H)=L(\tilde{H}) [symbol] \tilde{H}=HT (9)

In Equation (9), T denotes a unimodular matrix, which means a square matrix in which all elements are integers and a determinant is ±1. Herein, the LLL algorithm calculates the matrix \tilde{H} satisfying the above condition. If the matrix \tilde{H} satisfies the above condition, the matrix \tilde{H} will be referred to as a reduced matrix based on the LLL algorithm.

The reduced matrix \tilde{H} will now be defined as follows:

(1) \tilde{H}=\tilde{Q}\tilde{R}, where \tilde{Q} denotes a unitary matrix and \tilde{R} denotes an upper triangular matrix.

$$\begin{matrix}( 2 ) & \vert {\tilde{r}}_{l , k} \vert \leq \frac{1}{2} \vert {\tilde{r}}_{l , l} \vert for 1 \leq l < k \leq m \\ ( 3 ) & δ \cdot {\tilde{r}}_{k - 1 , k - 1}^{2} < {\tilde{r}}_{k , k}^{2} + {\tilde{r}}_{k - 1 , k}^{2} for 0.5 < δ \leq 1\end{matrix}$$

Herein, \tilde{r} denotes elements constituting the upper triangular matrix \tilde{R}, k denotes a signal receiving time, and l, k and m denote indexes defined by a size of the matrix. In addition, when the matrix \tilde{H} satisfies conditions (1) and (2), a size of vectors of the matrix \tilde{H} decreases. An arbitrary real number δ used affects the quality of the reduced vectors. When vectors of the matrix H are given, the LLL algorithm reduces the size so as to satisfy condition (2), and when condition (3) is not satisfied, the LLL algorithm permutes factors, i.e. vectors, of the matrix. In order to permute the vectors, such schemes as QR Decomposition and Stored QR can be used, by way of example. QR Decomposition decomposes a matrix into an orthogonal matrix Q and an upper triangular matrix R.

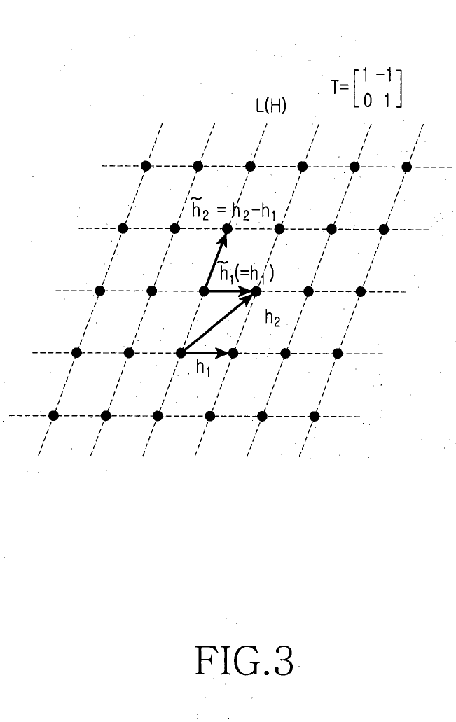

With reference to FIG. 3, a description will now be made of lattices constituting vectors of matrix \tilde{H} according to the LLL algorithm.

FIG. 3 is a diagram illustrating vectors obtained through a channel response matrix according to the present invention.

Referring to FIG. 3, a matrix T obtained after performing the LLL algorithm is shown. If the channel response matrix H is given, the unimodular matrix T is calculated by Equation (10):

$$\begin{matrix}H = \tilde{H} {T}^{- 1} ⇔ [ {\tilde{h}}_{1} \vert ⋯ \vert {\tilde{h}}_{m} ] = [ {h}_{1} \vert ⋯ \vert {h}_{m} ] \cdot [ \begin{matrix}{t}_{11} & ⋯ & {t}_{1 m} \\ ⋮ & ⋰ & ⋮ \\ {t}_{m 1} & ⋯ & {t}_{m m}\end{matrix} ] \\ ⇒ {\tilde{h}}_{i} = {t}_{1 i} \cdot {h}_{1} + {t}_{2 i} \cdot {h}_{2} + ⋯ + {t}_{m i} \cdot {h}_{m} = {\sum }_{k} {t}_{i k} \cdot {h}_{k}\end{matrix} \qquad ( 10 )$$

where t denotes an element of the unimodular matrix T, and i, m and k denote indexes determined by a size of the matrix.

In FIG. 3, LR-based lattice points and vectors h₁ and h₂ of the channel response matrix are shown. Vectors of the channel response matrix \tilde{H} converted from the matrix H can be defined as {\tilde{h}₁, . . . , \tilde{h}ₘ}. Herein, vectors of the channel response matrix \tilde{H} converted from the matrix H for the unimodular matrix

$$T = [ \begin{matrix}1 & - 1 \\ 0 & 1\end{matrix} ]$$

are shown as \tilde{h}₁ and \tilde{h}₂, by way of example. It can be noted that the matrix \tilde{H} decreases in size of the vector, compared with the matrix H.

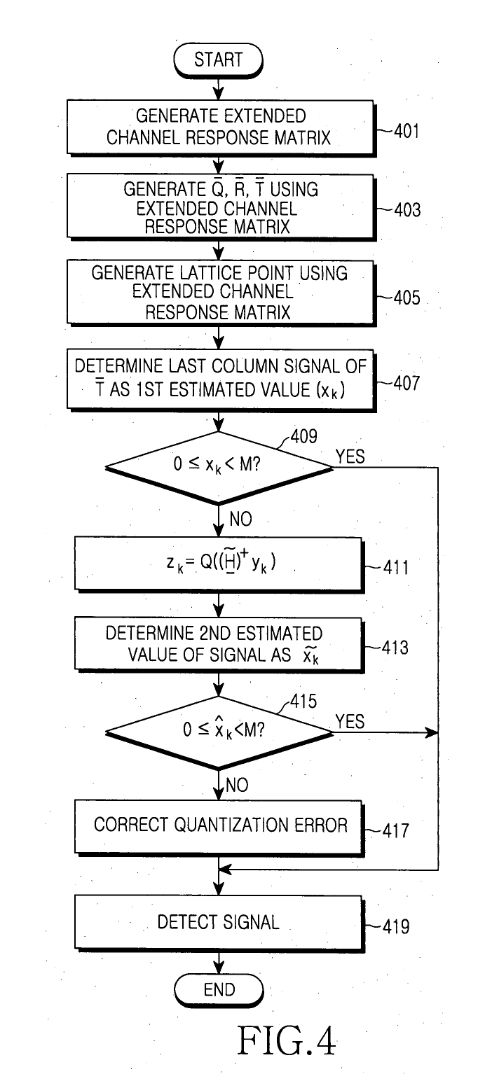

With reference to FIG. 4, a detailed description will now be made of an operation of performing signal detection according to the present invention.

FIG. 4 is a flowchart schematically illustrating an operation of a receiver in a MIMO communication system according to the present invention.

Before a description of FIG. 4 is given, it should be noted that the present invention relates to a receiver operation of detecting a received signal, and the operation will be described with reference to the LR-based receiver structure of FIG. 2.

Referring to FIG. 4, in step 401, the detector generates an extended channel response matrix H̅ by extending a channel response matrix H. A signal received at time k will be referred to as yₖ.

In step 403, the detector generates matrixes \tilde{Q}, \tilde{R} and T̅ by performing the LLL algorithm on the extended channel response matrix H̅. The matrixes Q̅, R̅ and T̅ are matrixes constituting the matrix H̅, and the matrixes constituting the matrix H̅ can be calculated by Equation (11):

$$\overline{H} = [ \begin{matrix}H & {y}_{k} \\ 0 & ɛ\end{matrix} ] {⟶}^{LLL \text{-} algorithm} \overline{Q} , \overline{R} , \overline{T} \qquad ( 11 )$$

where ε denotes an arbitrary real number greater than 1.

Herein, the reason why the matrixes Q̅, R̅ and T̅ are calculated by performing the LLL algorithm is because the channel is in a block fading environment. A relation between unitary matrixes Q and Q̅, upper triangular matrixes R and R̅, and unimodular matrixes T and T̅ calculated by applying the LLL algorithm to the matrix H at a start point of a frame is expressed as Equation (12):

$$\overline{Q} = [ \begin{matrix}Q & 0 \\ 0 & 1\end{matrix} ] \overline{R} = [ \begin{matrix}R & {Q}^{H} {y}_{k} \\ 0 & ɛ\end{matrix} ] \overline{T} = [ \begin{matrix}T & {\hat{x}}_{k} \\ 0 & 1\end{matrix} ] \qquad ( 12 )$$

Because the Q, R, T and the Q̅, R̅, T̅ are similar functions, they are expressed as unitary matrixes, upper triangular matrixes, and unimodular matrixes, and the matrixes have the above relationship. Therefore, calculation complexity can be reduced.

In step 405, the detector generates a lattice point L( H̅) depending on the matrix H̅. The generated lattice point L( H̅) is expressed as Equation (13):

$$L ( \overline{H} ) = \{ {\sum }_{i} {k}_{i} {\overline{h}}_{i} + k \cdot {\overline{y}}_{k} \vert {k}_{i} ∈ Z , {[ {y}_{k} ɛ ]}^{T} , and {\overline{h}}_{i} = {[ {h}_{i} 0 ]}^{T} \} \qquad ( 13 )$$

In step 407, the detector estimates a signal using the matrixes and the lattice point. Because the last norm of the matrix T̅ is an element having a considerably small L( H̅|k=1), the detector determines the estimated signal as a first estimated value.

If X_{ML}=\hat{k}₁h₁+ . . . +\hat{k}ₘhₘ∈L(H), the above two conditions are satisfied, and expressed as Equation (14):

$$\begin{matrix}\begin{matrix}[ \begin{matrix}\begin{matrix} {y}_{ k} & - {x}_{ ML}\end{matrix} \\ ɛ\end{matrix} ] = - {\sum }_{i} {\hat{k}}_{i} {\overline{h}}_{i} + \\ {\overline{y}}_{k} = [ {\overline{h}}_{1} , … , {\overline{h}}_{m} , {y}_{k} ] \cdot [ \begin{matrix}- {\hat{k}}_{1} \\ ⋮ \\ - {\hat{k}}_{m} \\ 1\end{matrix} ] ∈ L ( \overline{H} \vert k = 1 ) \\ {‖ [ \begin{matrix}\begin{matrix} {y}_{ k} & - {x}_{ ML}\end{matrix} \\ ɛ\end{matrix} ] ‖}^{2} {‖ {y}_{k} = {x}_{ML} {‖}^{2} + {ɛ}^{2} \leq ‖ {y}_{k} - x ‖}^{2} + {ɛ}^{2} = \\ {‖ \begin{matrix}\begin{matrix}{y}_{ k} & - x\end{matrix} \\ ɛ\end{matrix} ‖}^{2} for any x ∈ L ( \overline{H} )\end{matrix} & ( 14 )\end{matrix}$$

From Equation (14), a distance between the estimated signal and the actually received signal can be found, indicating that a distance between the signal estimated when the above condition is satisfied and the actually received signal is short. In Equation (14), ∥ ∥ denotes a size of a corresponding vector.

As described above, the detector estimates a transmission signal by partially performing calculation of the last column of the matrix T̅ using the LLL algorithm. To this end, the LLL algorithm corrects the k into n, and the detector estimates the first estimated value, i.e. a transmission signal xₖ from a transmitter, by performing the LLL algorithm.

In step 409, the detector determines whether the first estimated value falls within a predetermined allowable range, i.e. a range of 0≦xₖ≦M. The allowable range indicates a range that is set on the basis of a modulation level. Therefore, M indicates a predetermined modulation level.

If it is determined that the first estimated value falls within the allowable range, the detector proceeds to step 419 where it detects a signal with the first estimated value. However, if it is determined that the first estimated value does not fall within the allowable range, the detector proceeds to step 411.

In step 411, the detector calculates \hat{z}ₖ using a modified LR-MMSE scheme, and \hat{z}ₖ is expressed as Equation (15):
\hat{z}ₖ=Q((\tilde{H})⁻yₖ) (15)

After calculating Equation (15), the detector estimates, in step 413, a second estimated value \tilde{x}ₖ using \tilde{x}ₖ=T·\hat{Z}ₖ. The \hat{Z}ₖ has \hat{z}ₖ as an element.

In step 415, the detector determines whether the second estimated value falls within a predetermined allowable range, i.e. a range of 0≦xₖ<M.

If it is determined that the second estimated value falls within the allowable range, the detector proceeds to step 419 where it detects a signal with the second estimated value. However, if it is determined that the second estimated value does not fall within the allowable range, the detector proceeds to step 417.

In step 417, the detector performs a (±) operation on the detected signal and the matrix T. If it is determined in step 415 that the second estimated value does not fall within the allowable range, it can be assumed that there is a quantization error in \hat{z}ₖ. In this case, \hat{z}ₖ can be expressed as Equation (16):

$$\begin{matrix}\begin{matrix}{\hat{z}}_{k} = {z}_{k , True} \pm [ \begin{matrix}0 , … , 1 , … , 0 \\ i - th\end{matrix} ] ⇒ T \cdot {\hat{z}}_{k} \\ = T \cdot {\hat{z}}_{k , True} \pm T ( \text{:} , i ) ⇒ {\hat{x}}_{k} = {x}_{k , True} \pm T ( \text{:} , i )\end{matrix} & ( 16 )\end{matrix}$$

In Equation (16), k denotes time of a received signal, True denotes a signal actually transmitted by a transmitter, i-th denotes an i^{th} column vector, and T(:,i) denotes an i^{th} column vector of a matrix T.

As shown in Equation (16), the detector detects a signal in step 419 by performing a (±) operation on the unimodular matrix T.

The signal output from the detector is input to a demodulator, and the demodulator demodulates the signal output from the detector into the original information data bits using a demodulation scheme corresponding to the modulation scheme used in a modulator.

As can be understood from the foregoing description, in the MIMO communication system, the LR-based receiver detects the signal transmitted from the transmitter using the LR technique, and estimates the signal by extending the LLL algorithm and the MMSE technique. The application of the present invention facilitates signal detection with minimum complexity. In addition, the present invention can guarantee the signal detection performance similar to that of the Maximum Likelihood (ML) technique.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for detecting a signal in a communication system using a Multiple Input Multiple Output (MIMO) scheme, the method comprising:
generating second matrixes by extending a first matrix composed of channel response vectors;
generating specific matrixes by decomposing the second matrixes, and generating a lattice point of vectors constituting the second matrixes;
estimating a signal using the generated specific matrixes and lattice point; and
detecting the estimated signal as a received signal if the estimated signal has a value within a predetermined allowable range.

2. The method of claim 1, wherein the second matrix is generated by converting vectors constituting the first matrix into a roughly orthogonal form.

3. The method of claim 2, wherein the second matrix is expressed as
$$\underline{H} = [ \begin{matrix}H \\ {σ}^{2} I\end{matrix} ]$$
where H denotes the second matrix, H denotes the first matrix, σ denotes noise strength, and I denotes an identity matrix.

4. The method of claim 1, wherein the specific matrixes include a unitary matrix, an upper triangular matrix, and a unimodular matrix.

5. The method of claim 4, wherein the matrixes are generated using a Lenstra-Lenstra-Lovasz (LLL) algorithm.

6. The method of claim 1, wherein signal estimation comprises estimating a last column of a unimodular matrix as an estimated value of a signal transmitted from a transmitter.

7. The method of claim 1, wherein the allowable range is set depending on a modulation level.

8. The method of claim 1, further comprising setting a second estimated value using a Lattice Reduction-Minimum Mean Square Error (LR-MMSE) scheme of the following equation if the estimated signal does not fall within the allowable range,
\hat{x}ₖ=T·\hat{Z}ₖ
where \hat{x}ₖ denotes the second estimated value, T denotes a unimodular matrix, and \hat{Z}ₖ has \hat{z}ₖ=Q((\tilde{H})⁺yₖ as an element, where ( )⁺ denotes an operation with a Moore-Penrose Pseudo inverse matrix, yₖ denotes a signal received at time k, and Q( ) denotes a quantization function.

9. The method of claim 8, further comprising:
detecting the second estimated value as a received signal if the second estimated value falls within a predetermined allowable range; and
performing an operation on the second estimated value and a unimodular matrix and detecting the operation result as a received signal, if the second estimated value does not fall within the allowable range.

10. An apparatus for detecting a signal in a communication system using a Multiple Input Multiple Output (MIMO) scheme, the apparatus comprising:
a detector for generating second matrixes by extending a first matrix composed of channel response vectors, generating specific matrixes by decomposing the second matrixes, generating a lattice point of vectors constituting the second matrixes, estimating a signal using the generated specific matrixes and lattice point, and detecting the estimated signal as a received signal if the estimated signal has a value within a predetermined allowable range.

11. The apparatus of claim 10, wherein the second matrix is generated by converting vectors constituting the first matrix into a roughly orthogonal form.

12. The apparatus of claim 11, wherein the second matrix is expressed as
$$\underline{H} = [ \begin{matrix}H \\ {σ}^{2} I\end{matrix} ]$$
where H denotes the second matrix, H denotes the first matrix, σ denotes noise strength, and I denotes an identity matrix.

13. The apparatus of claim 10, wherein the specific matrixes include a unitary matrix, an upper triangular matrix, and a unimodular matrix.

14. The apparatus of claim 13, wherein the matrixes are generated using a Lenstra-Lenstra-Lovasz (LLL) algorithm.

15. The apparatus of claim 10, wherein the detector estimates a last column of a unimodular matrix as an estimated value of a signal transmitted from a transmitter.

16. The apparatus of claim 10, wherein the allowable range is set depending on a modulation level.

17. The apparatus of claim 10, wherein the detector sets a second estimated value using a Lattice Reduction-Minimum Mean Square Error (LR-MMSE) scheme of the following equation if the estimated signal does not fall within the allowable range,
\hat{x}ₖ=T·\hat{Z}ₖ
where \hat{x}ₖ denotes the second estimated value, T denotes a unimodular matrix, and \hat{Z}ₖ has \hat{z}ₖ=Q((\tilde{H})⁺yₖ) as an element, where ( )⁺ denotes an operation with a Moore-Penrose Pseudo inverse matrix, yₖ denotes a signal received at time k, and Q( ) denotes a quantization function.

18. The apparatus of claim 17, wherein the detector detects the second estimated value as a received signal if the second estimated value falls within a predetermined allowable range, and performs an operation on the second estimated value and a unimodular matrix and detects the operation result as a received signal, if the second estimated value does not fall within the allowable range.

19. The apparatus of claim 10, further comprising a demodulator for demodulating a detected symbol combination using a demodulation scheme corresponding to a modulation scheme used in a transmitter.
